(19) United States
(12) Patent Application Publication
(10) Pub. No.: US 2026/0038807 A1
(43) Pub. Date: Feb. 5, 2026

(54) POSITIVE ELECTRODES AND RECHARGEABLE LITHIUM BATTERIES INCLUDING THE SAME

(71) Applicant: SAMSUNG SDI CO., LTD., Yongin-si (KR)

(72) Inventors: Da-Un HAN, Yongin-si (KR); Yong-Kyun PARK, Yongin-si (KR); Yuhyun KIM, Yongin-si (KR); Sanghee NAM, Yongin-si (KR); Eunhyeon HA, Yongin-si (KR); Jingu YEOM, Yongin-si (KR); Mingu CHOI, Yongin-si (KR); Minju LEE, Yongin-si (KR); Junsik LEE, Yongin-si (KR); Donghyun KO, Yongin-si (KR)

(73) Assignee: SAMSUNG SDI CO., LTD., Yongin-si (KR)

(21) Appl. No.: 19/285,992

(22) Filed: Jul. 30, 2025

(30) Foreign Application Priority Data
Jul. 31, 2024 (KR) 10-2024-0102084

(51) Int. Cl. H01M 4/36; H01M 4/02; H01M 4/131; H01M 4/136; H01M 4/525; H01M 4/58; H01M 4/62; H01M 10/0525

(52) U.S. Cl. CPC H01M 4/364; H01M 4/131; H01M 4/136; H01M 4/525; H01M 4/5825; H01M 4/625; H01M 10/0525; H01M 2004/021; H01M 2004/028

(57) ABSTRACT

A positive electrode includes a positive electrode current collector; and a positive electrode active material layer on the positive electrode current collector and including a positive electrode active material and a conductive material. The positive electrode active material includes a first positive electrode active material including a lithium iron phosphate-based compound; and a second positive electrode active material including a lithium nickel-based composite oxide. A ratio of a specific surface area of the positive electrode active material to a specific surface area of the conductive material is in a range of about 1.3 to about 2.5. The positive electrode increases capacity while reducing production cost, thereby ensuring long cycle-life characteristics and improving high-voltage characteristics and high-temperature storage characteristics. The rechargeable lithium battery including the positive electrode can exhibit high initial charge/discharge capacity and efficiency even under high voltage driving conditions, and can implement long cycle-life characteristics.

### CROSS-REFERENCE TO RELATED APPLICATION

This application claims priority to Korean Patent Application No. 10-2024-0102084 filed in the Korean Intellectual Property Office on Jul. 31, 2024, the entire contents of which are incorporated herein by reference.

### BACKGROUND

### 1. Field

Positive electrodes, and rechargeable lithium batteries including the positive electrodes, are disclosed.

### 2. Description of the Related Art

A portable information device such as, e.g., a cell phone, a laptop, smart phone, and the like, or an electric vehicle, typically uses a rechargeable lithium battery having high energy density and portability as a driving power source. It may be advantageous to produce a rechargeable lithium battery with high energy density as a driving power source or power storage power source for hybrid or electric vehicles.

Various positive electrode active materials can be used in rechargeable lithium batteries for the above applications. In the increasing demand for large-sized, high-capacity, or high-energy-density rechargeable lithium batteries, developing positive electrode active materials and conductive materials that can increase capacity while ensuring stability and enable operation at high voltages may be advantageous.

### SUMMARY

Some example embodiments include a positive electrode active material and a conductive material capable of achieving high density, high capacity, long cycle-life characteristics and high energy density, as well as a positive electrode and a rechargeable lithium battery using the positive electrode active material.

In some example embodiments, a positive electrode includes a positive electrode current collector; and a positive electrode active material layer located on the positive electrode current collector and including a positive electrode active material and a conductive material. The positive electrode active material includes a first positive electrode active material including a lithium iron phosphate-based compound; and a second positive electrode active material including a lithium nickel-based composite oxide. A ratio of a specific surface area of the positive electrode active material to a specific surface area of the conductive material is in a range of about 1.3 to about 2.5.

In some example embodiments, a rechargeable lithium battery including the positive electrode, a negative electrode, and an electrolyte is provided.

The positive electrode according to some example embodiments increases capacity while reduces production cost, thereby ensuring long cycle-life characteristics and improving high-voltage characteristics and high-temperature storage characteristics. The rechargeable lithium battery including the positive electrode may exhibit high initial charge/discharge capacity and efficiency even under high voltage driving conditions, and can implement long cycle-life characteristics.

### BRIEF DESCRIPTION OF THE DRAWINGS

FIGS. 1 to 4 are views schematically illustrating a lithium rechargeable battery according to some example embodiments.

### DETAILED DESCRIPTION

Hereinafter, example embodiments are described in detail so that those of ordinary skill in the art can readily implement them. However, this disclosure may be embodied in many different forms and is not construed as limited to the example embodiments set forth herein.

The terminology used herein is only used to describe example embodiments, and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, the element can be “directly on” the other element, or intervening elements may also be present therebetween. In contrast, when an element is referred to as being “directly on” another element, no intervening elements may be present therebetween.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may indicate the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of +10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

### Positive Electrode

In some example embodiments, a positive electrode includes a positive electrode current collector; and a positive electrode active material layer on the positive electrode current collector and including a positive electrode active material and a conductive material. The positive electrode active material includes a first positive electrode active material including a lithium iron phosphate-based compound; and a second positive electrode active material including a lithium nickel-based composite oxide. A ratio of a specific surface area of the positive electrode active material to a specific surface area of the conductive material is in a range of about 1.3 to about 2.5. The positive electrode active material layer may further include other types of positive electrode active materials in addition to the aforementioned positive electrode active materials. Additionally, the positive electrode active material layer may optionally further include a binder.

The positive electrode achieves safety by using a mixture of the lithium iron phosphate-based compound and the lithium nickel-based composite oxide as a positive electrode active material, thereby increasing the capacity and enabling operation at high voltage. By desiredly controlling the specific surface area ratio of the positive electrode active material and the conductive material, it is possible to improve high-temperature storage performance.

### Positive Electrode Active Material Layer

According to some example embodiments, a positive electrode active material layer is on a positive electrode current collector and includes a positive electrode active material and a conductive material. The positive electrode active material includes a first positive electrode active material containing a lithium iron phosphate-based compound, and a second positive electrode active material including a lithium nickel-based composite oxide.

The first positive electrode active material according to some example embodiments includes a lithium iron phosphate-based compound. The lithium iron phosphate-based compound can play a role in improving heat resistance and thermal stability, while also increasing capacity or increasing output. For example, the lithium iron phosphate-based compound may be represented by Chemical Formula 1 or Chemical Formula 2.

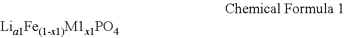

In Chemical Formula 1, 0.90≤a1≤1.5, 0≤x1≤0.4, and M1 is or includes at least one of Al, B, Ca, Ce, Cr, Cu, La, Mg, Mn, Mo, Nb, Ni, Si, Sn, Sr, Ti, V, W, Y, Zn, Zr, and a combination thereof. Herein, 0.90≤a1≤1.5, for example, 0.90≤a1≤1.2, or 0.95≤a1≤1.1. Additionally, 0≤x1≤0.4, 0≤x1≤0.3, 0≤x1≤0.2, 0≤x1≤0.1, or 0≤x1≤0.05.

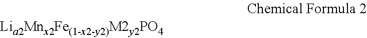

In Chemical Formula 2, 0.90≤a2≤1.5, 0.1≤x2≤0.9, 0≤y2≤0.9, and M2 is or includes at least one of Al, B, Ca, Ce, Cr, Cu, La, Mg, Mo, Nb, Ni, Si, Sn, Sr, Ti, V, W, Y, Zn, Zr, and a combination thereof. Herein, 0.90≤a2≤1.5, or for example, 0.90≤a2≤1.2, or 0.95≤a2≤1.1. Additionally, 0.1≤x2≤0.9, 0.3≤x2≤0.9, or 0.4≤x2≤0.8, and 0≤y2≤0.4, 0≤y2≤0.3, 0≤y2≤0.2, 0≤y2≤0.1, or 0≤y2≤0.05.

For example, the lithium iron phosphate-based compound may include at least one of LifePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, and a combination thereof.

The first positive electrode active material including the lithium iron phosphate-based compound is in the form of particles, and the average particle diameter (D₅₀) of the particles may be in a range of about 0.01 μm to about 2 μm, for example, about 0.1 μm to about 1 μm, or about 0.2 μm to about 0.9 μm. As used herein, when a definition is not otherwise provided, the average particle diameter (D₅₀) indicates a diameter of particles having a cumulative volume of 50 volume % in the particle size distribution that is obtained by measuring the size (diameter or major axis length) of about 20 particles at random in a scanning electron microscope image for positive electrode active materials.

In some example embodiments, the lithium iron phosphate-based compound may be in the form of first particles, second particles, or a mixture of first particles and second particles.

The first particles may be or include an assembly of multiple nano-sized primary particles or a secondary particle. The primary particles may have a substantially spherical or substantially ellipsoidal shape as the primary particles are closely packed together. The average particle diameter of the first particles may be, for example, in a range of about 2 μm to about 15 μm, about 3 μm to about 12 μm, or about 3 μm to about 10 μm. The average particle diameter of the first particle may be larger than the average particle diameter of the second particle, which is described below. The average particle diameter of the primary particles of the first particle may be, for example, in a range of about 10 nm to about 400 nm, about 20 nm to about 300 nm, or about 50 nm to about 200 nm. For example, the average particle diameter of the first particles may be obtained by randomly selecting about 30 first particles from an electron microscope image of a lithium transition metal phosphate, measuring the particle diameter, and taking the diameter (D₅₀) of the particles having a cumulative volume of 50 volume % from the particle size distribution as the average particle diameter. The average particle diameter of the primary particles of the first particle may be obtained by measuring the sizes of about 30 primary particles in an electron microscope image of the surface or cross-section of the first particle and taking the diameter (D₅₀) of the particles having a cumulative volume of 50 volume % in the particle size distribution as the average particle diameter.

A porosity of the first particle may be in a range of about 20% to about 50%. The porosity may be obtained by measuring an area ratio of the portion occupied by pores within the particle using an image analysis program such as Image J in a scanning electron microscope image of a cross-section of the first particle.

The second particle may be in the form of a single particle. An average particle diameter of the second particles may be, for example, in a range of about 10 nm to about 900 nm, about 50 nm to about 500 nm, or about 100 nm to about 300 nm. The average particle diameter of the second particles may be smaller than the average particle diameter of the first particles, and may be equal to or larger than the average particle diameter of the primary particles of the first particles. For example, the average particle diameter of the second particles can be obtained by randomly selecting about 30 second particles from an electron microscope image of a lithium iron phosphate-based compound, measuring the particle sizes, and taking the diameter (D₅₀) of the particles having a cumulative volume of 50 volume % from the particle size distribution as the average particle diameter.

The lithium iron phosphate-based compound may further include a carbon coating layer on the particle surface. The carbon coating layer may improve the electrical conductivity of the lithium iron phosphate-based compound and reduce the resistance of the positive electrode. The carbon coating layer may be formed using at least one raw material such as or including, for example, at least one of glucose, sucrose, lactose, starch, oligosaccharide, polyoligosaccharide, fructose, cellulose, a polymer of furfuryl alcohol, a block copolymer of ethylene and ethylene oxide, a vinyl resin, a cellulose resin, a phenol resin, a pitch resin, and a tar resin. For example, the carbon coating layer may be formed by arranging the raw materials on the surface of the lithium iron phosphate-based compound particles, and subsequently performing a sintering process.

The second positive electrode active material according to some example embodiments includes a lithium nickel-based composite oxide. By including the lithium nickel-based composite oxide, characteristics of lithium iron phosphate-based compounds such as heat resistance and thermal stability are maintained, while the capacity is increased and operation at high voltage is enabled. For example, the lithium nickel-based composite oxide may be represented by Chemical Formula 3.

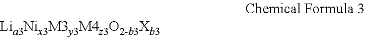

In Chemical Formula 3, 0.9≤a3≤1.8, 0.3≤x3≤1, 0≤y3≤0.7, 0≤z3≤0.7, 0.9≤x3+y3+z3≤1.1, and 0≤b3≤0.1, and M3 and M4 each independently is or includes one or more of from Al, B, Ba, Ca, Ce, Co, Cr, Cu, Fe, Mg, Mn, Mo, Nb, Si, Sn, Sr, Ti, V, W, Zn, and Zr, and X is or includes one or more of F, P, and S.

In Chemical Formula 3, 0.6≤x3≤1, 0≤y3≤0.4, and 0≤z3≤0.4, or 0.8≤x3≤1, 0≤y3≤0.2, and 0≤z3≤0.2, or 0.9≤x3≤1, 0<y3≤0.1, and 0≤z3≤0.1.

For example, the second positive electrode active material may be or include a high nickel-based positive electrode active material in which a nickel content is greater than or equal to about 80 mol %, greater than or equal to about 85 mol %, greater than or equal to about 90 mol %, greater than or equal to about 91 mol %, greater than or equal to about 94 mol %, or greater than or equal to 99 mol % based on 100 mol % of a total metal excluding lithium in the lithium transition metal composite oxide (e.g., the lithium nickel-based composite oxide). The high nickel-based positive electrode active material may achieve high capacity, and may be applied to high-capacity, high-density rechargeable lithium batteries.

The second positive electrode active material including the lithium nickel-based composite oxide may be in the form of particles, and the particles may be in the form of secondary particles formed by agglomeration of a plurality of primary particles, single particles, or a combination thereof. The secondary particles and single particles may be substantially spherical, substantially elliptical, polyhedral, or irregular in shape, and primary particles constituting the secondary particles may be substantially spherical, substantially elliptical, plate-shaped, or a combination thereof.

An average particle diameter (D₅₀) of the second positive electrode active material may be in a range of about 10 μm to about 25 μm, for example about 11 μm to about 20 μm, or about 12 μm to about 18 μm. As used herein, when a definition is not otherwise provided, the average particle diameter (D₅₀) indicates a diameter of particles having a cumulative volume of 50 volume % in the particle size distribution that is obtained by measuring the size (diameter or major axis length) of about 20 particles at random in a scanning electron microscope image for positive electrode active materials.

The first positive electrode active material may be included in an amount in a range of about 10 wt % to about 90 wt %, for example, about 50 wt % to about 90 wt %, about 60 wt % to about 90 wt %, or about 70 wt % to about 90 wt %, and, the second positive electrode active material may be included in an amount in a range of about 10 wt % to about 90 wt %, for example, about 10 wt % to about 50 wt %, about 10 wt % to about 40 wt %, or about 10 wt % to about 30 wt % based on 100 wt % of the first positive electrode active material and the second positive electrode active material. When the contents of the first positive electrode active material and the second positive electrode active material are within the above ranges, it is possible to increase the capacity and enable operation at high voltage while ensuring sufficient safety.

### Conductive Material

The conductive material is included to provide electrode conductivity, and any electrically conductive material may be used as a conductive material unless the electrically conductive material causes a chemical change. Examples of the conductive material may include a carbon-based material such as at least one of natural graphite, artificial graphite, carbon black, acetylene black, ketjen black, a carbon fiber, a carbon nanofiber, a carbon nanotube, and particulate nanocarbon; a metal-based material including at least one of copper, nickel, aluminum, silver, and the like in the form of metal powder or metal fiber; a conductive polymer such as a polyphenylene derivative; or a combination thereof.

For example, the conductive material may include fibrous carbon including a carbon nanotube, a carbon nanofiber, or a combination thereof, may include particulate nanocarbon including amorphous carbon such as at least one of carbon black, acetylene black, or ketjen black, or may include a combination of fibrous carbon and particulate nanocarbon. The above nanocarbon may have a particle diameter in a range of several nanometers to several hundred nanometers, for example, in a range of about 1 nm to about 900 nm, about 10 nm to about 600 nm, or about 20 nm to about 200 nm.

For example, the conductive material may include fibrous carbon and particulate nanocarbon, wherein the fibrous carbon and the particulate nanocarbon may have a weight ratio in a range of about 10:90 to about 90:10, for example, about 20:80 to about 80:20, about 30:70 to about 70:30, or about 40:60 to about 60:40. When the fibrous carbon and the particulate nanocarbon are mixed within the above ranges, resistance of a positive electrode including the first and second positive electrode active materials may not only be reduced, but also capacity may be increased, thus improving overall electrochemical performance.

The conductive material may be included in an amount in a range of about 1.0 wt % to about 2.5 wt %, for example, about 1.1 wt % to about 2.4 wt %, about 1.2 wt % to about 2.3 wt %, about 1.3 wt % to about 2.2 wt %, about 1.4 wt % to about 2.1 wt %, or about 1.5 wt % to about 2.0 wt % based on 100 wt % of the positive electrode active material layer. When the content of the conductive material is within the above range, the resistance of the positive electrode including the first positive electrode active material and the second positive electrode active material may be lowered, thereby increasing the capacity of the battery and enabling operation at high voltage.

A ratio of a specific surface area of the positive electrode active material to the specific area of the conductive material may be in a range of about 1.3 to about 2.5, for example, about 1.3 to about 2.4, about 1.3 to about 2.3, about 1.3 to about 2.2, about 1.3 to about 2.1, or about 1.3 to about 2.0. The ratio of the specific surface area of the positive electrode active material to the specific surface area of the conductive material may be used to determine a degree to which the surface of the positive electrode active material is covered by the conductive material, wherein when the ratio of the specific surface area of the positive electrode active material to the specific area of the conductive material falls within the above ranges, a conductive path may be desiredly formed, and simultaneously or contemporaneously, the conductive material may not block the surface of the positive electrode active material, thereby improving high-temperature storage performance and enabling battery operation at a high voltage.

The ratio of the specific surface area of the positive electrode active material to the specific area of the conductive material may be obtained, for example, by randomly measuring a size (a diameter, major axis length, or a height) of about 20 particles from a scanning electron microscope image of a positive electrode cross-section to obtain a particle size distribution, which is used to obtain a particle surface area, and then calculating a ratio of the particle surface area to the particle weight.

### Binder

The binder improves binding properties of positive electrode active material particles with one another and with a current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

A content of the binder may be in a range of about 0.5 wt % to about 5 wt % based on 100 wt % of the positive electrode active material layer.

The positive electrode current collector may include Al, and the like, but is not limited thereto.

### Rechargeable Lithium Battery

Some example embodiments provide a rechargeable lithium battery including the aforementioned positive electrode, negative electrode, and electrolyte. As an example, the rechargeable lithium battery may include a positive electrode, a negative electrode, a separator between the positive electrode and the negative electrode, and an electrolyte solution.

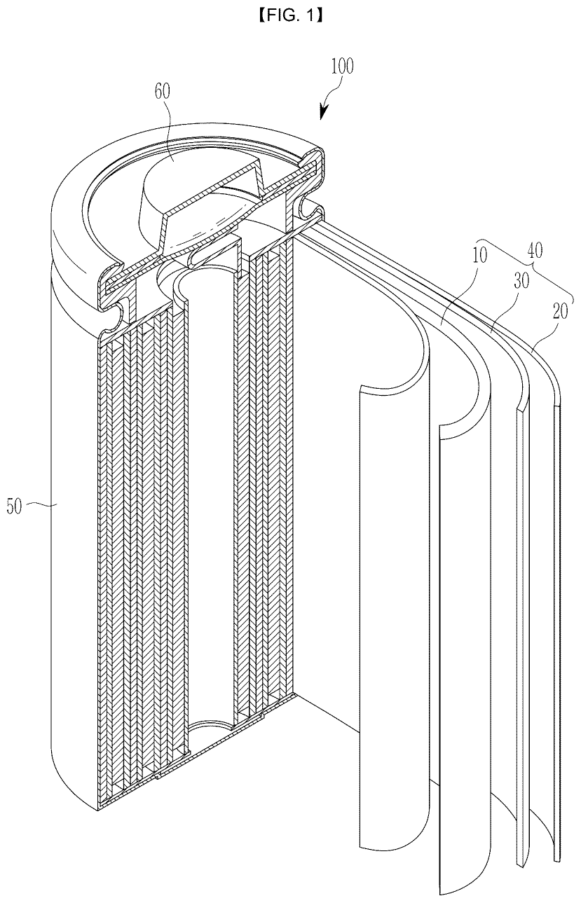

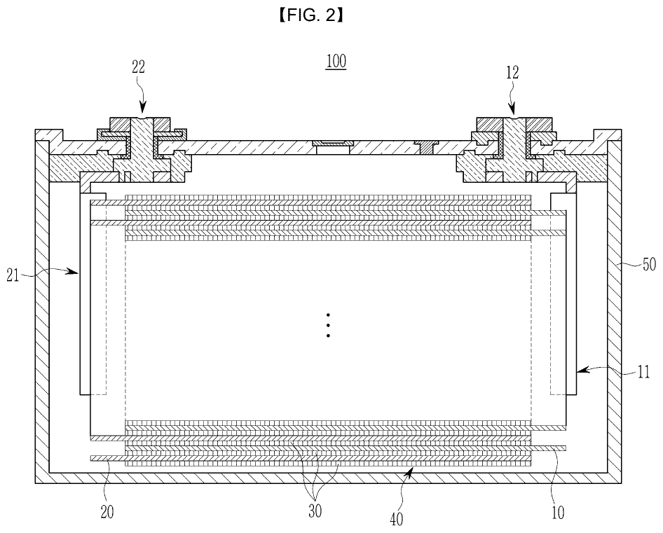

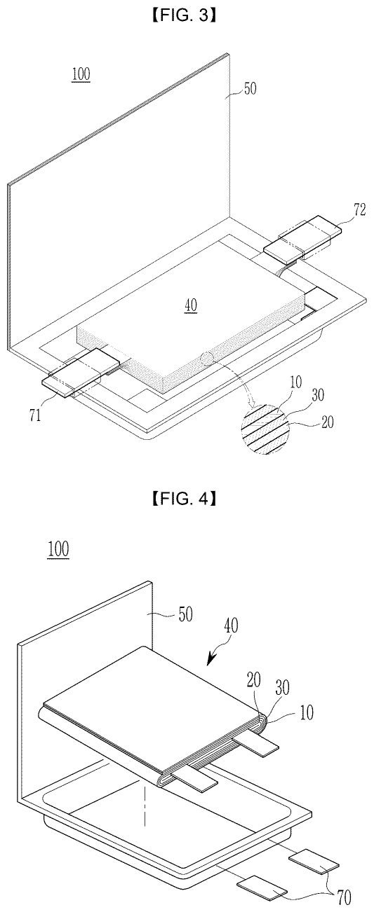

The rechargeable lithium battery may be classified into cylindrical, prismatic, pouch, coin, and the like, depending on the shape. FIGS. 1 to 4 are schematic views illustrating the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative electrode lead tab 21, and a negative electrode terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

The rechargeable lithium battery according to some example embodiments may be rechargeable at a high voltage, or suitable for being driven at the high voltage, and exhibit improved characteristics thereof under the high voltage condition.

The rechargeable lithium battery according to some example embodiments are configured to operate in a high voltage region, so that charging can proceed in a voltage range where the charging upper limit voltage is greater than or equal to about 4.0 V. The rechargeable lithium battery may achieve high capacity and long cycle-life characteristics, even when charged at high voltage by applying a positive electrode active material and a conductive material according to some example embodiments.

### Negative Electrode

The negative electrode may include a current collector and a negative electrode active material layer on the current collector, and the negative electrode active material layer may include a negative electrode active material, and may further include a binder, a conductive material, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, substantially spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include at least one of a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon or hard carbon, a mesophase pitch carbonized product, and calcined coke.

When the silicon-carbon composite includes silicon and amorphous carbon, a content of silicon may be in a range of about 10 wt % to about 50 wt %, and a content of amorphous carbon may be in a range of about 50 wt % to about 90 wt % based on 100 wt % of the silicon-carbon composite. In addition, when the composite includes silicon, amorphous carbon, and crystalline carbon, a content of silicon may be in a range of about 10 wt % to about 50 wt %, a content of crystalline carbon may be in a range of about 10 wt % to about 70 wt %, and a content of amorphous carbon may be in a range of about 20 wt % to about 40 wt % based on 100 wt % of the silicon-carbon composite.

Additionally, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may be included as silicon alone, in the form of a silicon alloy, or in an oxidized form. The oxidized form of silicon may be represented by SiOₓ (0<x≤2). At this time, the atomic content ratio of Si:O, which indicates a degree of oxidation, may be in a range of about 99:1 to about 33:67. As used herein, when a definition is not otherwise provided, an average particle diameter (D₅₀) indicates a diameter of a particle where an accumulated volume is about 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed, the mixing ratio may be a weight ratio in a range of about 1:99 to about 90:10.

### Binder

The binder is configured to adhere the negative electrode active material particles to each other, and to adhere the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

### Conductive Material

The conductive material is included to provide electrode conductivity and any electrically conductive material may be included as a conductive material unless the electrically conductive material causes a chemical change. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

A content of the negative electrode active material may be in a range of about 95 wt % to about 99.5 wt % based on 100 wt % of the negative electrode active material layer, and a content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent is configured as a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether group, and the like; amides such as dimethylformamide; dioxolanes such as 1,3-dioxolane, 1,4-dioxolane, and the like; sulfolanes, and the like.

The non-aqueous organic solvent can be included alone or in a mixture of two or more types of solvents, and when two or more types of solvents are included in a mixture, a mixing ratio can be desiredly adjusted according to the desired battery performance, which is widely known to those working in the field.

When using a carbonate-based solvent, a cyclic carbonate and a chain carbonate may be mixed, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

A concentration of lithium salt may be within the range of about 0.1 M to about 2.0 M. When the concentration of lithium salt is within the above range, the electrolyte solution has a desired ionic conductivity and viscosity, and thus a desired or improved performance can be achieved and lithium ions can move effectively.

### Separator

Depending on the type of rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof, on one surface, or on both surfaces, of the porous substrate.

The porous substrate may be or include a polymer film formed of or including any one polymer such as at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

Examples and comparative examples of the present disclosure are described below. However, the following examples are only examples of the present disclosure, and the present disclosure is not limited to the following examples.

### Example 1

### 1. Preparation of First Positive Electrode Active Material

A first positive electrode active material containing LiFePO₄ as a lithium iron phosphate-based compound was prepared. Subsequently, Ni_{0.75}Co_{0.24}Al_{0.01}(OH)₂ and LiOH were mixed in a mole ratio of 1:1.05 and then, primarily heat-treated at 845° C. for 8 hours under an oxygen atmosphere to prepare a second positive electrode active material containing a lithium nickel-cobalt-aluminum-based composite oxide having a composition of Li_{1.05}Ni_{0.75}Co_{0.24}Al_{0.01}O₂ in the form of secondary particles with an average particle diameter (D₅₀) of about 14 μm. Finally, based on 100 wt % of the first and second positive electrode active materials, 90 wt % of the first positive electrode active material and 10 wt % of the second positive electrode active material were mixed to prepare a positive electrode active material.

### 2. Manufacturing of Rechargeable Lithium Battery Cell

96.3 wt % of the finally prepared positive electrode active material, 2.2 wt % of a polyvinylidene fluoride binder, and 1.5 wt % of a conductive material prepared by mixing carbon nanotube and particulate nanocarbon in a weight ratio of 7:3 were mixed to prepare a positive electrode active material layer slurry, which was coated on an aluminum foil current collector and then, dried and compressed to manufacture a positive electrode. Additionally, a specific surface area ratio of the positive electrode active material/the conductive material was calculated by randomly measuring particle diameters of about 20 particles from a scanning electron microscope image of a positive electrode cross-section to obtain a particle size distribution, which was used to obtain a surface area of the particles, and then calculating a ratio of the particle surface area to the particle weight, and the results are shown in Table 1 below.

A negative electrode active material layer slurry was prepared by mixing 97 wt % of a graphite negative electrode active material, 0.5 wt % of particle-shaped nanocarbon, 0.8 wt % of carboxymethyl cellulose, and 1.7 wt % of a styrene butadiene rubber in a solvent. The negative electrode active material layer slurry was coated on a copper foil current collector, and then dried and compressed to manufacture a negative electrode.

A polytetrafluoroethylene separator was used, and an electrolyte solution prepared by dissolving 1 M LiPF₆ in a mixed solvent of ethylene carbonate and dimethyl carbonate in a volume ratio of 3:7 was used to manufacture a rechargeable lithium battery cell in a common method.

### Examples 2 to 8

A positive electrode and a rechargeable lithium battery cell were manufactured substantially in the same manner as in Example 1 with a difference that each content of the first and second positive electrode active materials based on 100 wt % of a total amount of the first and second positive electrode active materials and each content of the positive electrode active material and the conductive material based on 100 wt % of a total amount of the positive electrode active material layer in the manufacture of the positive electrode were changed as shown in Table 1 below.

### Comparative Examples 1 to 11

A positive electrode and a rechargeable lithium battery cell were manufactured substantially in the same manner as in Example 1 with a difference that each content of the first and second positive electrode active materials based on 100 wt % of a total amount of the first and second positive electrode active materials and each content of the positive electrode active material and the conductive material based on 100 wt % of a total amount of the positive electrode active material layer in the manufacture of the positive electrode were changed as shown in Table 1 below.

TABLE 1

| | | | | | Specific |
|---|---|---|---|---|---|
| | | | | | surface |
| | | | | | area |
| | | | | | ratio of |
| | First | Second | | | positive |
| | positive | positive | Positive | | electrode |
| | electrode | electrode | electrode | | active |
| | active | active | active | Conductive | material/ |
| | material | material | material | material | conductive |
| | (wt %) | (wt %) | (wt %) | (wt %) | material |
| Example 1 | 90 | 10 | 96.3 | 1.5 | 2.1 |
| Example 2 | 85 | 15 | 96.3 | 1.5 | 2.0 |
| Example 3 | 80 | 20 | 96.3 | 1.5 | 1.9 |
| Example 4 | 70 | 30 | 96.3 | 1.5 | 1.7 |
| Example 5 | 90 | 10 | 95.8 | 2.0 | 1.6 |
| Example 6 | 85 | 15 | 95.8 | 2.0 | 1.5 |
| Example 7 | 80 | 20 | 95.8 | 2.0 | 1.4 |
| Example 8 | 70 | 30 | 95.8 | 2.0 | 1.3 |
| Comparative | 90 | 10 | 97.3 | 0.5 | 6.4 |
| Example 1 | | | | | |
| Comparative | 85 | 15 | 97.3 | 0.5 | 6.1 |
| Example 2 | | | | | |
| Comparative | 80 | 20 | 97.3 | 0.5 | 5.8 |
| Example 3 | | | | | |
| Comparative | 70 | 30 | 97.3 | 0.5 | 5.1 |
| Example 4 | | | | | |
| Comparative | 90 | 10 | 96.8 | 1.0 | 3.2 |
| Example 5 | | | | | |
| Comparative | 85 | 15 | 96.8 | 1.0 | 3.0 |
| Example 6 | | | | | |
| Comparative | 80 | 20 | 96.8 | 1.0 | 2.9 |
| Example 7 | | | | | |
| Comparative | 90 | 10 | 95.3 | 2.5 | 1.2 |
| Example 8 | | | | | |
| Comparative | 85 | 15 | 95.3 | 2.5 | 1.2 |
| Example 9 | | | | | |
| Comparative | 80 | 20 | 95.3 | 2.5 | 1.1 |
| Example 10 | | | | | |
| Comparative | 70 | 30 | 95.3 | 2.5 | 1.0 |
| Example 11 | | | | | |

### Evaluation Example 1: DC-IR Evaluation

The rechargeable lithium battery cells according to Examples 1 to 8 and Comparative Examples 1 to 11 were charged to an upper limit voltage of 4.2 V (vs. Li/Li⁺) from 2.5 V at a constant current of 0.33 C, paused for 10 minutes, and discharged to 2.5 V at 0.33 C at 25° C. for initial charging and discharging. Herein, a change in DC-IR after a predetermined period of time from initial DC-IR (direct current internal resistance) was measured, and the results are shown in Table 2 below.

TABLE 2

| | 10 days have | 20 days have | 30 days have |
|---|---|---|---|
| | passed | passed | passed |
| Example 1 | 99.6 | 102.9 | 109.4 |
| Example 2 | 102.2 | 105 | 108.2 |
| Example 3 | 98.2 | 100 | 106.2 |
| Example 4 | 97.7 | 97.5 | 99.8 |
| Example 5 | 88.7 | 84.4 | 83 |
| Example 6 | 94.2 | 93.6 | 93.8 |
| Example 7 | 92.2 | 97.1 | 96.9 |
| Example 8 | 96.7 | 100.6 | 111.2 |
| Comparative Example 1 | 139.5 | 184.8 | 222.4 |
| Comparative Example 2 | 145.2 | 185 | 209 |
| Comparative Example 3 | 144.1 | 182.9 | 202.4 |
| Comparative Example 4 | 116.6 | 144.4 | 172.5 |
| Comparative Example 5 | 116.1 | 123.9 | 140.7 |
| Comparative Example 6 | 113.5 | 120.4 | 137.3 |
| Comparative Example 7 | 113.8 | 120.9 | 137.1 |
| Comparative Example 8 | 114.3 | 116.5 | 128.3 |
| Comparative Example 9 | 112.1 | 117.8 | 129 |
| Comparative Example 10 | 133.9 | 185 | 270.5 |
| Comparative Example 11 | 178.5 | 227.9 | 327.9 |

Referring to Table 2 above, the examples that satisfy the specific surface area ratio ranges of the positive electrode active material/the conductive material exhibited no high increase resistance rate, even when stored at a high temperature, but the comparative examples that do not satisfy the specific surface area ratio ranges of the positive electrode active material/the conductive material exhibited a high increase resistance rate, when stored at the high temperature.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a positive electrode current collector; and
a positive electrode active material layer on the positive electrode current collector and including a positive electrode active material and a conductive material;
wherein the positive electrode active material comprises a first positive electrode active material including a lithium iron phosphate-based compound; and a second positive electrode active material including a lithium nickel-based composite oxide; and
a ratio of a specific surface area of the positive electrode active material to a specific surface area of the conductive material is in a range of about 1.3 to about 2.5.

2. The positive electrode as claimed in claim 1, wherein the lithium iron phosphate-based compound is represented by one of Chemical Formula 1 and Chemical Formula 2: 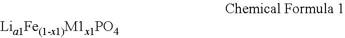
wherein, in Chemical Formula 1, 0.90≤a1≤1.5, 0≤x1≤0.4, and M1 comprises at least one of Al, B, Ca, Ce, Cr, Cu, La, Mg, Mn, Mo, Nb, Ni, Si, Sn, Sr, Ti, V, W, Y, Zn, and Zr, and 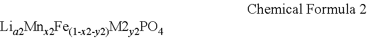
wherein, in Chemical Formula 2, 0.90≤a2≤1.5, 0.1≤x2≤0.9, 0≤y2≤0.9, and M2 comprises at least one of Al, B, Ca, Ce, Cr, Cu, La, Mg, Mo, Nb, Ni, Si, Sn, Sr, Ti, V, W, Y, Zn, and Zr.

3. The positive electrode as claimed in claim 1, wherein the lithium iron phosphate-based compound comprises at least one of LifePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, and LiMn_{0.3}Fe_{0.7}PO₄.

4. The positive electrode as claimed in claim 1, wherein the lithium nickel-based composite oxide has a nickel content that is equal to or greater than about 80 mol % based on 100 mol % of a total metal excluding lithium in the lithium nickel-based composite oxide.

5. The positive electrode as claimed in claim 1, wherein the lithium nickel-based composite oxide is represented by Chemical Formula 3:
Liₐ₃Niₓ₃M3_{y3}M4_{z3}O_{2-b3}X_{b3} Chemical Formula 3:
wherein, in Chemical Formula 3, 0.9≤a3≤1.8, 0.3≤x3≤1, 0≤y3≤0.7, 0≤z3≤0.7, 0.9≤x3+y3+z3≤1.1, and 0≤b3≤0.1, M3 and M4 each independently comprises one or more of Al, B, Ba, Ca, Ce, Co, Cr, Cu, Fe, Mg, Mn, Mo, Nb, Si, Sn, Sr, Ti, V, W, Zn, and Zr, and X comprises one or more of F, P, and S.

6. The positive electrode as claimed in claim 1, wherein the first positive electrode active material is included in an amount in a range of about 10 wt % to about 90 wt %, and the second positive electrode active material is included in an amount in a range of about 10 wt % to about 90 wt %, based on 100 wt % of the first positive electrode active material and the second positive electrode active material.

7. The positive electrode as claimed in claim 1, wherein the first positive electrode active material is included in an amount in a range of about 70 wt % to 90 wt %, and the second positive electrode active material is included in an amount in a range of about 10 wt % to about 30 wt %, based on 100 wt % of the first positive electrode active material and the second positive electrode active material.

8. The positive electrode as claimed in claim 1, wherein a ratio of a specific surface area of the positive electrode active material to a specific surface area of the conductive material is in a range of about 1.3 to about 2.0.

9. The positive electrode as claimed in claim 1, wherein the conductive material comprises at least one of a fibrous carbon including at least one of a carbon nanotube and a carbon nanofiber; and a particle-shaped nanocarbon including amorphous carbon.

10. The positive electrode as claimed in claim 9, wherein the conductive material comprises the fibrous carbon and the particulate nanocarbon.

11. The positive electrode as claimed in claim 1, wherein the conductive material is included in an amount in a range of about 1.0 wt % to about 2.5 wt % based on 100 wt % of the positive electrode active material layer.

12. The positive electrode as claimed in claim 1, wherein the conductive material is included in an amount in a range of about 1.5 wt % to about 2.0 wt % based on 100 wt % of the positive electrode active material layer.

13. A rechargeable lithium battery, comprising:
the positive electrode as claimed in claim 1,
a negative electrode, and
an electrolyte.

14. The rechargeable lithium battery as claimed in claim 13, wherein a charging upper limit voltage is equal to or greater than about 4.0 V.

15. The rechargeable lithium battery as claimed in claim 13, wherein the negative electrode comprises at least one of a carbon-based negative electrode active material, a lithium metal, a lithium metal alloy, and a silicon-based negative electrode active material.
